(19) United States
(12) Patent Application Publication
(10) Pub. No.: US 2021/0325687 A1
(43) Pub. Date: Oct. 21, 2021

(54) SYSTEM AND METHOD FOR CONTACTING A DEVICE BASED ON EYE'S MOVEMENT

(71) Applicant: HISEP TECHNOLOGY LTD., Yavne (IL)

(72) Inventors: YARIV ERAD, KIDRON (IL); GAD VERED, BE'ER YA'AKOV (IL); URI VERED, RISHON LEZION (IL); MENACHEM ERAD, ASHDOD (IL)

(21) Appl. No.: 17/233,659

(22) Filed: Apr. 19, 2021

Related U.S. Application Data
(60) Provisional application No. 63/012,173, filed on Apr. 19, 2020.

(51) Int. Cl. G02B 27/20; G02B 27/00; G02B 27/01; G06K 19/06

(52) U.S. Cl. CPC G02B 27/20; G02B 27/0093; G02B 27/0172; G02B 2027/0178; G06K 19/06009; G02B 2027/0138; G02B 27/0101

(57) ABSTRACT

A system including a wearable device having a sensor directed towards a person's eyes, for detecting a direction at which the person looks, a beam emitter for emitting a beam at the direction at which the person looks as detected by the sensor, a processor for activating the beam emitter to emit the beam at the direction at which the person looks as detected by the sensor, and an electronic device, coupled to a tag, where the tag reacts when the beam hits the tag, where the reaction includes performing an action at the electronic device.

### FIELD

The present disclosure generally relates to contacting a device based on eye's movement.

### BACKGROUND

In recent years there is a growing use of wireless connectivity. The growing trend of “Internet of Things” (IoT) results in that almost every device and object can be coupled with sensors and Wireless Communication components, to enable the device's connection to the Internet and to other devices around it.

Part of such use is to integrate sensors and wireless communication components in everyday items at home appliances—as well as in industrial or commercial items. Smart home devices include means to voice-activate smart home appliance that are wirelessly connected to a smart home hub device (that can be for example a smart speaker equipped with microphones).

Yet, from the user's perspective, one of the most intuitive ways to filter between the items the user wishes to interact with is by looking at the items. There are prior-art systems that aim to remotely monitor the user's eyes, and to extrapolate where the user is looking and on what device/item the user is looking. For example, a smart speaker equipped with cameras. However, such system and devices require unobstructed continuous line-of-sight (LOS) between the camera and the user's eyes, as well as the ability to correctly identify the item the user is looking at (i.e., unobstructed line-of-sight to it as well).

In many real-life situations, while the user may have unobstructed LOS with the item he wishes to interact with, there might not be such LOS between the user and the smart-home hub/smart speaker, or between the smart home hub to the item.

In addition, the growing awareness of people to avoid touching surfaces and items, especially in public places and in places such as hospitals or point-of-care places, created a need to offer a solution to reduce the number of physical interactions with objects, and to offer alternative means to do so, which are simple and intuitive. Therefore, there is a need to offer a simple solution that can enable a user to freely and accurately interact with items.

### SUMMARY

The subject matter discloses a system and a method that tracks a user's eye movement, and accordingly directs a beam to the direction the user is looking at, in order to enable the user to interact with that device. Interaction comprises activation, deactivation, control, sending or receiving data, operating the device and additional interactions desired by a person skilled in the art. The system may be embedded in a wearable device worn by the user, the device having means to monitor the user's eye, in such manner that the electronic device can determine the direction at which the user is looking.

Said electronic device may include means to activate a beam that is directed to the direction at which the user is looking, thus “pointing” on an object or device the user is looking at. The user may choose to conduct an interaction with said device, such as activate and/or control and/or operate and/or receive or send data to/from the device. Both the wearable device and the electronic device the user interacts with—may include sensors, and by pointing said devices may exchange sensor data between them or send data to the other.

The subject matter, in embodiments thereof, discloses a system, comprising a wearable device, comprising: a sensor directed towards the person's eyes, for detecting a direction at which the person looks; a beam emitter for emitting a beam at the direction at which the person looks as detected by the sensor; a processor for activating the beam emitter to emit the beam at the direction at which the person looks as detected by the sensor; an electronic device, coupled to a tag, wherein the tag reacts when the beam hits the tag, wherein the reaction comprises performing an action at the electronic device.

In some cases, the wearable device further comprising an input unit for receiving an input from a user of the wearable device concerning an action desired to be performed by the electronic device, and wherein performing the action in response to the beam hitting the tag. In some cases, the wearable device further comprising a direction finding unit for determining a relative direction of the tag relative to the wearable device. In some cases, the beam comprises information collected at the electronic device.

In some cases, the device further comprises an actuator for moving the beam emitter towards the direction at which the person looks. In some cases, the device further comprises multiple beam emitters, wherein the processor is coupled to the sensor and to the multiple beam emitters, wherein the processor selects a selected beam emitter from the multiple beam emitters.

In some cases, the processor selects at least two beam emitters from the multiple beam emitters, wherein the at least two beam emitters emit beams concurrently at multiple electronic devices. In some cases, the device further comprises an input unit for receiving an input from a user of the wearable device, said input comprising an interaction method with the electronic device. In some cases, the device further comprising a camera and a camera actuator, wherein the camera actuator moves the camera towards the direction at which the person looks.

In other embodiments, the subject matter to disclose a wearable device worn by a person, comprising a sensor directed towards the person's eyes, for detecting a direction at which the person looks, a beam emitter for emitting a beam at the direction at which the person looks as detected by the sensor; a processor for activating the beam emitter to emit the beam at the direction at which the person looks as detected by the sensor.

In some cases, the beam emitter is a laser beam emitter. In some cases, the beam emitter is a light beam emitter. In some cases, the device further comprises an actuator for moving the beam emitter towards the direction at which the person looks. In some cases, the device further comprises multiple beam emitters, wherein the processor is coupled to the sensor and to the multiple beam emitters, wherein the processor selects a selected beam emitter from the multiple beam emitters.

In some cases, the processor selects at least two beam emitters from the multiple beam emitters, wherein the at least two beam emitters emit beams concurrently at multiple electronic devices. In some cases, the device further comprises an input unit for receiving an input from a user of the wearable device, said input comprising an interaction method with the electronic device.

In some cases, the input unit comprises an interface in which the user of the wearable device determines a width of the beam. In some cases, the processor identifies multiple electronic devices located in the direction at which the person looks and selects a selected electronic device of the multiple electronic devices based on predefined rules.

In some cases, the processor identifies the person based on predefined rules and operates the beam emitter based on the person's identity and preferences associated with the identified person as stored in a memory coupled to the processor. In some cases, the beam comprises information collected at the electronic device. In some cases, the device further comprising a camera and a camera actuator, wherein the camera actuator moves the camera towards the direction at which the person looks.

In some cases, the device further comprises a sensor, wherein information collected from the sensor is transferred to the processor, wherein the processor determines how to use the beam emitter based on the collected information. In some cases, the wearable device is glasses, wherein the glasses comprise a lens coating for coating the glasses lens to reduce exposure to the beam. In some cases, the device further comprising a wireless communication unit for sending a wireless signal to an electronic device at which the beam is emitted.

### BRIEF DESCRIPTION OF THE DRAWINGS

The invention may be more clearly understood upon reading of the following detailed description of non-limiting exemplary embodiments thereof, with reference to the following drawings, in which:

FIG. 1 schematically shows an eyeglasses system, according to exemplary embodiments of the invention;

FIG. 2 schematically shows an electrical circuitry of the eyeglasses system and the user's eye, according to exemplary embodiments of the invention;

FIG. 3 schematically shows an eyeglasses system and the user wearing the eyeglasses, according to exemplary embodiments of the invention;

FIGS. 4A-4B schematically show an eyeglasses system worn by the user interacting with another device, according to exemplary embodiments of the invention;

FIG. 5 schematically shows an eyeglasses system having direction finding capabilities worn by the user interacting with another device, according to exemplary embodiments of the invention;

FIGS. 6A-6D schematically show a user of an eyeglasses system user interacting with another device, according to exemplary embodiments of the invention;

FIG. 7 schematically shows a method for emitting a beam based on a direction of a user's pupil, according to exemplary embodiments of the invention;

FIG. 8 schematically shows a method for interacting with an electronic device using a beam emitted from a wearable device, according to exemplary embodiments of the invention;

FIG. 9 schematically shows the computerized components of the wearable device, according to exemplary embodiments of the invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

For the purposes of this paper, and in order to enable clear understanding of the invention described herewith, the definitions and terms used in this paper shall have the meaning set forth beside them as well as the broadest meaning resulting from their context. However, it should be clearly understood, that the use of such meanings shall in no way serve to limit the scope of possible interpretation of the ideas, and the ideas and concepts provided herewith shall apply even if other terms and definitions are used.

The examples provided in this paper relate to the use of the invention for various applications. However, it is clearly stated that the use of the invention can apply to other types of applications and devices (such as speakers, smart phones), and for any device or application. In these cases, the features of the inventions described hereunder shall apply as well.

The subject matter discloses a wearable device, comprising a sensor directed towards the person's eyes, for detecting a direction at which the person looks. The wearable device also comprises a beam emitter for emitting a beam at the direction at which the person looks as detected by the sensor and a processor for activating the beam emitter to emit the beam at the direction at which the person looks as detected by the sensor. The beam may be defined as directional particles emitted intentionally. The particles may be formed in a straight line, as a sinusoidal wave, or in any other form of a wave. The beam may be a laser beam, a light beam, light in a non-seen wavelength, or any other beam desired by a person skilled in the art. The wearable device may be in a form-factor of eyeglasses. The wearable device may be in the form of transparent eye protectors. The wearable device may be in the form of transparent face protecting shield.

The term “direction” may be defined as an azimuth. The term “direction” may also be defined as a combination of azimuth and an angle defined between the user's look direction and the ground. The term “direction” may also be defined as a range of azimuths or offsets, for example offset of 10-12 degrees from the current direction of the beam emitter.

The sensor directed towards the person's eyes may be an image sensor such as a camera, or any other sensor desired by a person skilled in the art to detect a person's eye and an iris movement.

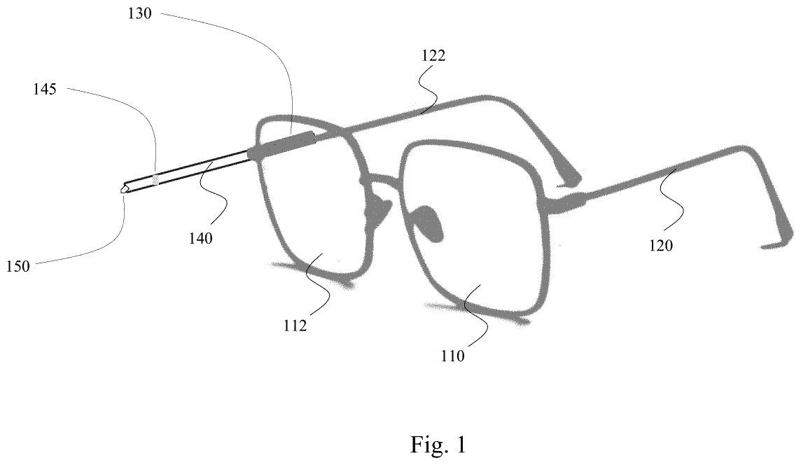

FIG. 1 schematically shows an eyeglasses system, according to exemplary embodiments of the invention. The eyeglasses system comprises two lenses 110, 112 and a frame having at least a pair of temples 120, 122 or another type of connector to connect the lenses 110, 112, to the user's head. The eyeglasses system further comprises an electrical circuitry 130 containing a sensor directed towards the user's eye. The eyeglasses system may comprise two sensors directed towards both eyes of the user. The electrical circuitry 130 may be coupled to one of the eyeglasses' temples 120, 122, to the lenses' frame or another part of the eyeglasses system.

The eyeglasses system may also comprise a pin 140 extending forward from the temple 122. The pin 140 may be removable from the eyeglasses system by the user. The pin 140 comprises a beam emitter 150. The pin 140 may also comprise a camera directed forward, as forward is defined away from the user's face. The beam may be a light beam, for example a laser beam or an infra-red beam.

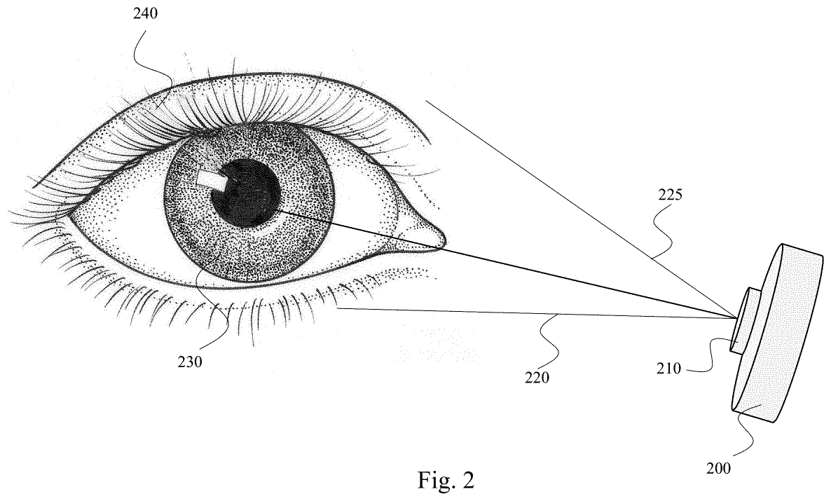

FIG. 2 schematically shows an electrical circuitry of the eyeglasses system and the user's eye, according to exemplary embodiments of the invention. The electrical circuitry comprises a sensor 210 directed towards the user's eye 240, detecting the location of the pupil 230 inside the eye 240. The sensor 210 may be an image sensor, a camera, or any other sensor capable of detecting the location of the pupil 230 inside the eye 240. The sensor 210 may have a detection range defined between imaginary lines 220 and 225. The sensor's direction relative to the eye 240 may be adjusted by a user of the eyeglasses system. The electrical circuitry may be placed inside a housing 200, to protect the electrical components therein, such as a memory, processor, communication components and the like.

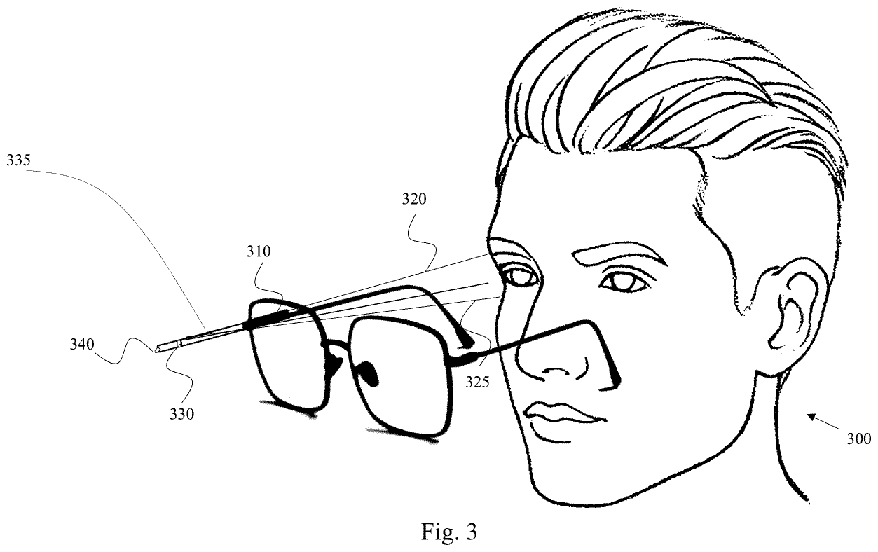

FIG. 3 schematically shows an eyeglasses system and the user wearing the eyeglasses, according to exemplary embodiments of the invention. The eyeglasses system comprise temples configured to be mounted on the user's ears. The sensor is located in housing 310, directed at the user's eye, or both eyes. The sensor's detection range may be defined by imaginary lines 320 and 325. The pin 335 may be coupled to the eyeglasses body, for example to the temple or to the lenses' frame. The housing 310 may be coupled to the pin 335. The pin 335 may extend upwards from the eyeglasses body. The beam emitter 340 may be located in a distal part of the pin 335, away from the lenses. The pin 335 may also comprise a camera. The camera may be directed away from the user, for example in the range of 140-220 degrees from the lenses surface.

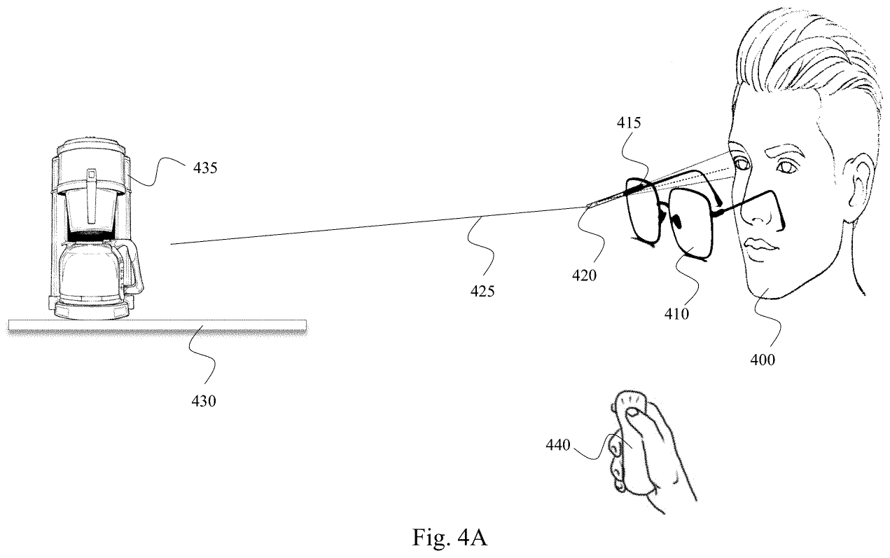

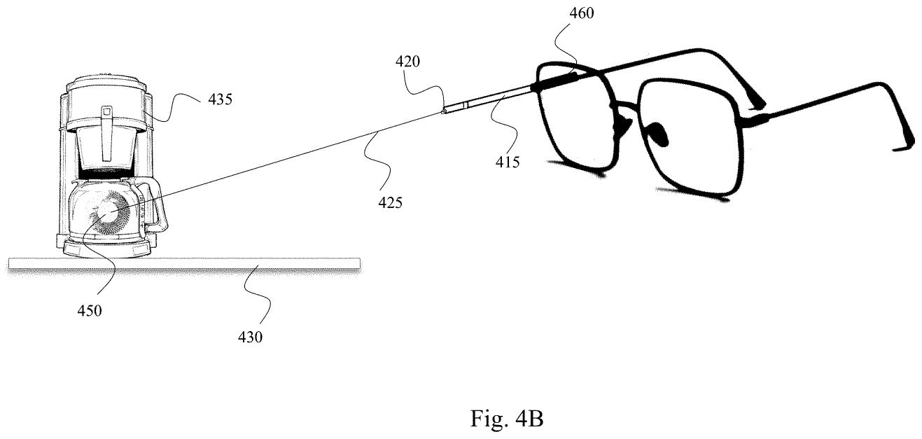

FIGS. 4A-4B schematically show an eyeglasses system worn by the user interacting with another device, according to exemplary embodiments of the invention. The user 400 wishes to interact with a coffee machine 435, or with any other electronic device, without approaching the coffee machine 435, and without the need to communicate with a third party device, such as a smart-home server. The coffee machine 435 may be mounted on a shelf 430.

The user 400 utilizes the eyeglasses system 410 in order to interact with the coffee machine 435. The sensor located in the circuitry 460 of the eyeglasses system 410 detects the direction of the user's eye. The beam emitter 420 may automatically emit a beam 425 in the direction detected by the sensor. The beam emitter 420 may emit the beam in response to a predefined rule, for example detecting the user's eye are fixed in a specific direction for a time duration higher than a threshold (such as for example 8 seconds). In some other cases, the user 400 may use a control device 440 coupled to the eyeglasses system 410, either via a cable or via a wireless communication technique. When the user presses on the control device 440, a command is sent to the beam emitter 420 to emit the beam 425 according to the location of the user's pupil. The beam 425 may be received at a beam receiver, coupled to electrical circuitry of the coffee machine 435.

FIG. 4B shows a coffee machine 435 comprising a tag 450. The tag 450 is able to process the beam 425 received from the eyeglasses system 410. For example, activate the coffee machine 430 when receiving the beam 425. The user 400 may determine which action to perform by the coffee machine using the control device 440, or using another device communicating with the eyeglasses system 410, such as cellular phone, tablet and the like.

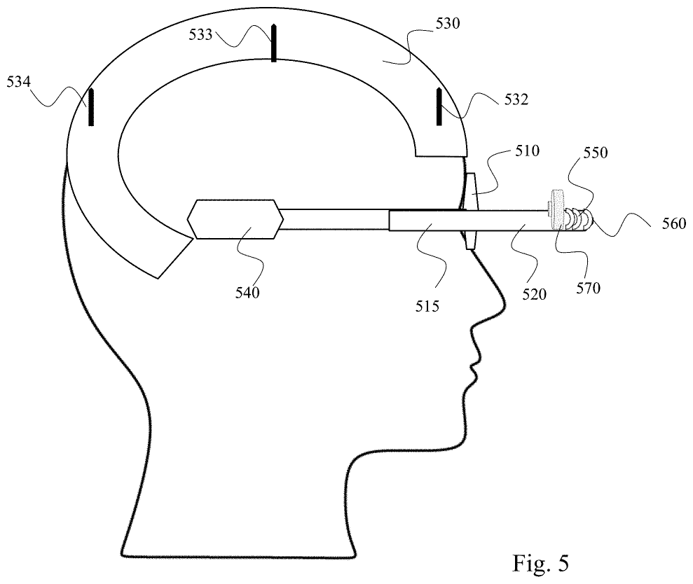

FIG. 5 schematically shows an eyeglasses system having direction finding capabilities worn by the user interacting with another device, according to exemplary embodiments of the invention. The eyeglasses system comprises a body, the body comprising a head-cover 530 secured on top of the user's head. The head cover 530 may be coupled to the frame of the eyeglasses system, for example to the temples 515 or the lenses' frame 510. The system comprises multiple antennas 532, 533, 534 for receiving signals, such as wireless signals, light signals, heat signals and the like. The multiple antennas 532, 533, 534 may be located inside the head cover 530. The multiple antennas 532, 533, 534 may be used to determine a relative direction and/or a relative location of a source of the signals collected by the multiple antennas 532, 533, 534.

The system also comprises electrical circuitry 540 coupled to the temple 515. The electrical circuitry 540 may comprise a memory, a wireless communication unit, a processor and additional components. The electrical circuitry 540 may be coupled to the beam emitter 560. The system may also comprise an actuator 550 for moving the beam emitter 560. The actuator 550 may move the beam emitter around an axis, in a lateral manner, on a horizontal axis, from right to left. The actuator 550 may receive movement commands from the processor located in the electrical circuitry 540. The system may also comprise a camera 570 directed away from the user. The camera 570, the actuator 550 and the beam emitter 560 may be coupled to the pin 520, as described above.

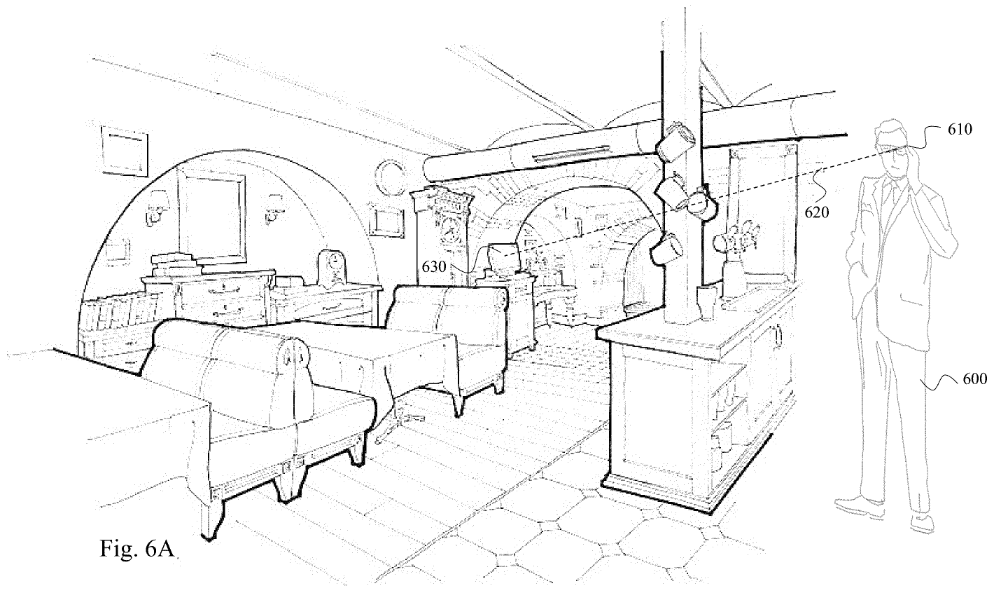

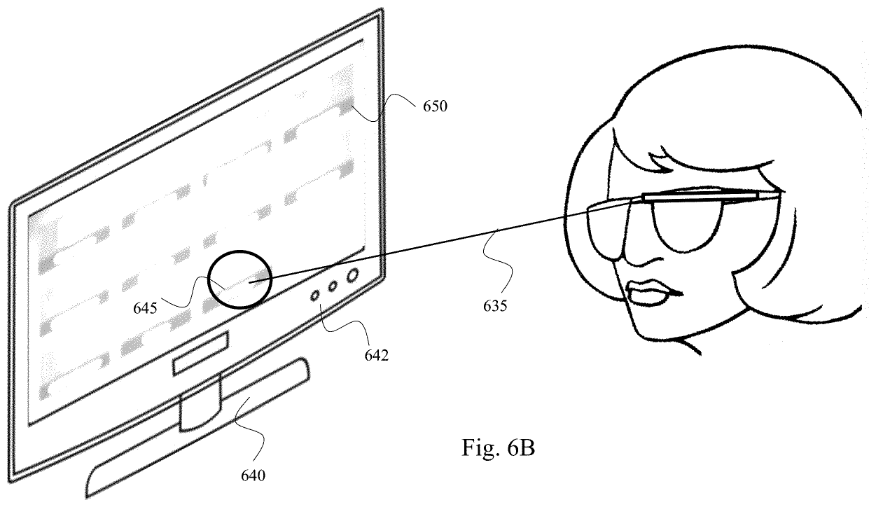

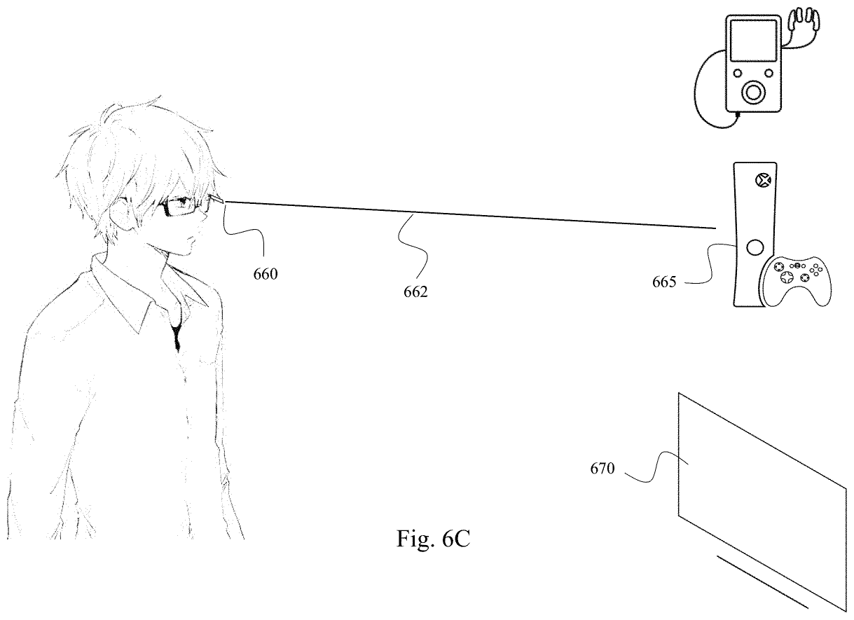

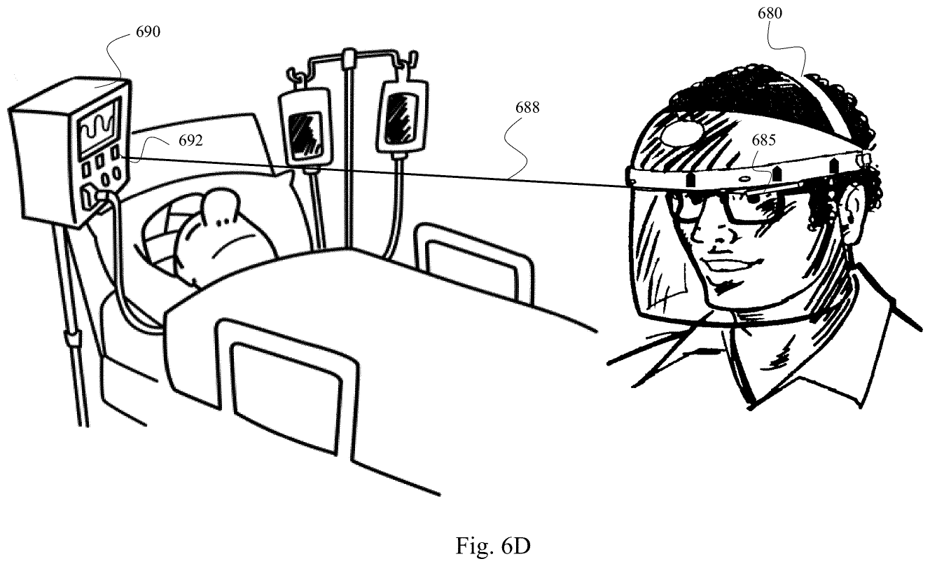

FIGS. 6A-6D schematically show a user of an eyeglasses system user interacting with another device, according to exemplary embodiments of the invention.

In FIG. 6A, the user 600 utilizes beam emitter 610 to interact with electronic device 630, such as a display device. The technical requirement to interact with the electronic device 630 is a direct line of sight between the electronic device 630 and the beam emitter 610 located on, or coupled to, the user's eyeglasses system. This way, the beam 620 emitted by the beam emitter 610 can access the electronic device 630.

In FIG. 6B, the user interacts with content displayed on an interface area 650 of a screen 642. The interface area may be the window in which an interface of a specific application is displayed, such as a browser, media player, software development platform and the like. The beam 635 is emitted based on the location of the user's eye pupil, at a certain area 645 in the interface area 650. The area 645 may also be defined as effective area when the user enters a lock state on at the direction of the certain area 645. The locking enables the user to interact with the buttons or interface located in the effective area 645 using the beam. Then, the user can interact with the specific application using the beam, for example by inputting information, virtually “pressing” on a button on the application, and the like. The screen 642 may be mounted on a screen base 640.

The user may input data into the interface located in the effective area 645 using another device, such as a keypad or keyboard coupled to the eyeglasses system, after the effective area 645 is locked. The locking may take place in response to a predefined event, such as a time duration in which the pupil is in a specific location, or detection of a gesture made by the user using a sensor such as a camera.

In FIG. 6C, the beam emitter 660 emits a beam 662 after the user enters into lock state at the gaming console 665. Once the user enters the lock state, the user can interact with the gaming console 665. Interacting may include entering commands into the gaming console, moving a figure or object displayed on display device 670 coupled to the gaming console 665.

In FIG. 6D, the user wears a head cover 680, and the beam emitter 685 is coupled to the head cover 680, not to eyeglasses as shown above. The beam emitter 685 emits a beam 688 towards effective area 692 of monitor 690. The beam 688 may carry information, such as medical information or an identifier of the user. The information included in the beam 688 may enable the monitor system 690 to send, enable access or display information to the user.

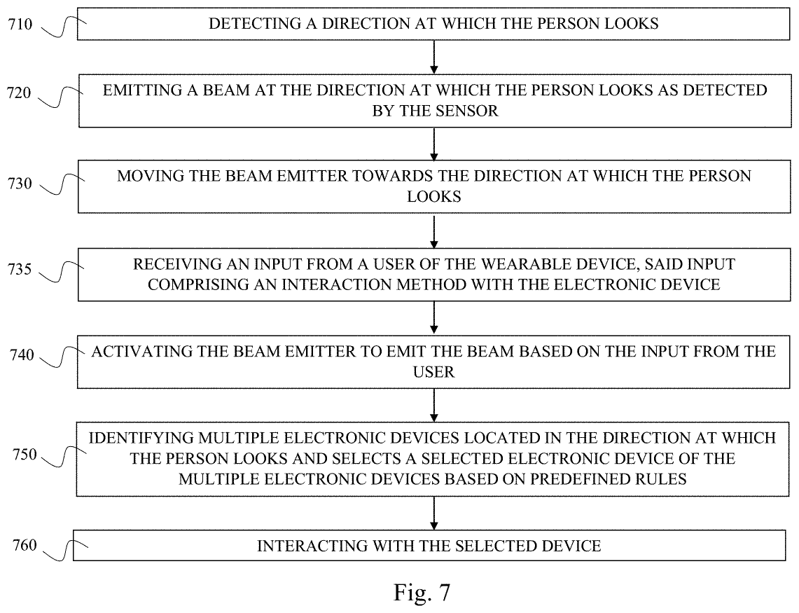

FIG. 7 schematically shows a method for emitting a beam based on a direction of a user's pupil, according to exemplary embodiments of the invention.

Step 710 discloses detecting a direction at which the person looks. Such detection may be defined by an area of the user's eye, for example ranging from left-mid left-middle-mid right-right. The detection may be more accurate, for example a specific offset from the center of the user's eye. In another example, the direction may be defined as “32 degrees to the right, 10 degrees up”. The direction may be determined by a processor coupled to the sensor that captures an image of the user's eye.

Step 720 discloses emitting a beam at the direction at which the person looks as detected by the sensor. The beam may be limited in time or terminate in response to an event. The user may control the time duration of the beam.

Step 730 discloses moving the beam emitter towards the direction at which the person looks. The beam emitter may move using an actuator or by the user. The beam emitter may be coupled to a mechanism that facilitates movement, such as a joint. The actuator may move the beam emitter in response from the processor, such as “move the beam emitter 22 degrees to the left”.

Step 735 discloses receiving an input from a user of the wearable device, said input comprising an interaction method with the electronic device. The input may be received using a speaker, based on a user's gesture captured by the camera, or from an electronic device coupled to the wearable device, such as a smartphone, tablet, laptop and the like. The input may comprise a selection of an interaction process, such as activation, sending a command, changing a mode of operation of another device that the beam hits, and the like.

Step 740 discloses activating the beam emitter to emit the beam based on the input from the use. The user's input may be received via a sensor or via the communication unit of the wearable device. Then, the input is transferred to the processor that generates a command to the beam emitter. The command may also be sent to the actuator, in case there is a need to move the beam emitter.

Step 750 discloses identifying multiple electronic devices located in the direction at which the person looks and selecting a selected electronic device of the multiple electronic devices based on predefined rules. The beam ray may be directed at several devices, such as an oven, microwave oven and a Toaster. However, the user only wishes to interact with a single device, such as the microwave oven. The processor selects the microwave oven based on a rule, such as “contact only white devices”, “contact only devices manufactured by a specific manufacturer”, “contact only devices in a limited size range” and the like. In some other cases, the selection of the selected device may be performed based on a user's input, which may be received via a speaker, a sensor or a device communicating with the wearable device.

Step 760 discloses interacting with the selected device. Interaction may comprise activating, deactivating, changing an operation mode of the selected device, changing a property in the device operation, such as temperature, volume, amount, power, and the like. Interaction may also comprise sending information to or receiving information from the device.

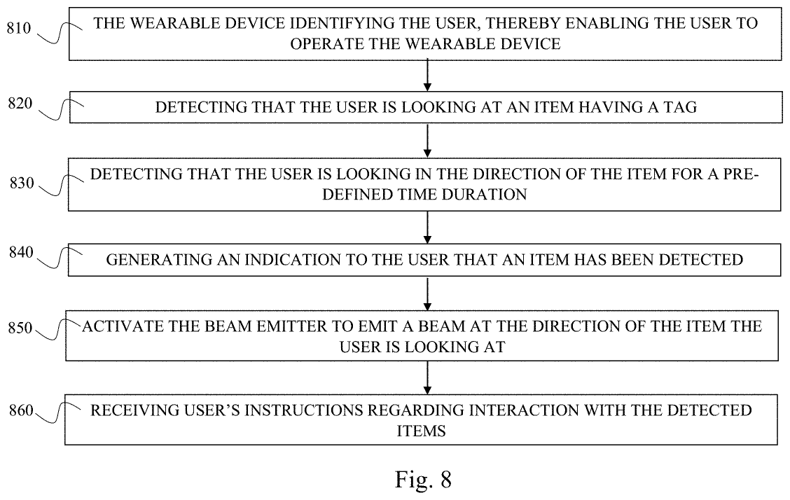

FIG. 8 schematically shows a method for interacting with an electronic device using a beam emitted from a wearable device, according to exemplary embodiments of the invention.

Step 810 discloses the wearable device identifying the user, thereby enabling the user to operate the wearable device. Identifying the user may be performed via authentication information, such as username and password. Identifying may be performed based on biometric information, such as fingerprints, identifying the user's iris, or the user's voice, or a combination of the above.

Step 820 discloses detecting that the user is looking at an item having a tag. First, the sensor detects the direction of the user's sight. Then, the processor computes the angle at which the user looks. Then, a camera may capture an image at the direction of the user's sight and the processor may determine whether or not the image includes an electronic device having a tag. The wearable device's memory may store a list of devices having tags in the vicinity of the user, for example at the user's home, vehicle, office, hotel room and the like.

Step 830 discloses detecting that the user is looking in the direction of the item for a predefined time duration. The predefined time duration is sufficient to be defined as a lock state, in which the user locks his/her sight at a specific direction.

Step 840 discloses generating an indication to the user that an item has been detected. The indication may include sound, light, vibration, or a combination of both. The indication may be a signal sent to the user's device such as a cellular phone.

Step 850 discloses activating the beam emitter to emit a beam at the direction of the item the user is looking at. The beam may be limited in time, or terminate in response to an event. The user may control the time duration of the beam.

Step 860 discloses receiving user's instructions regarding interaction with the detected items. Interaction may comprise activating, deactivating, changing an operation mode of the selected device, changing a property in the device operation, such as temperature, volume, amount, power, and the like. Interaction may also comprise sending information to or receiving information from the device.

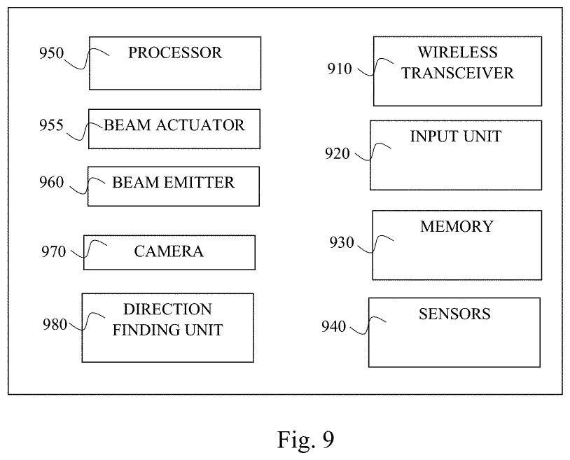

FIG. 9 schematically shows the computerized components of the wearable device, according to exemplary embodiments of the invention.

The wearable device comprises a wireless transceiver 910 for exchanging wireless communication with another electronic device, exchanging comprises at least one of sending and receiving signals. The wireless transceiver 910 wireless may enable a wearable device to wirelessly communicate with other wearable devices in its wireless communication range—either directly or via other such wearable device acting as relays.

The wireless transceiver 910 enables the wearable device to transfer information and/or data and/or packets (formatted blocks of data) and/or communication, acknowledgment/no-acknowledgment and/or voice over long or short distances without the use of electrical conductors or “wires”. The wireless transceiver 910 may use Radio waves and/or light waves and/or sound waves, at any given frequency—such as, but not limited to—5 Khz-600 Ghz.

The wireless transceiver 910 may use any protocol or standard in any given frequency that can be used to conduct Radio and/or light and/or sound Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”. It should be clearly stated that among such protocols, but not limited only to them, are Wi-Fi, Bluetooth, Low-Energy-Bluetooth (BLE), UWB, Wi-Max, ZigBee, Z-wave, Insteon, Cellular devices communication protocols, Near-field Communication (NFC), RFID protocols or standards. The protocols also refer to the use of such protocols over any radio frequency, such as—but not limited to, UHF, HF, VHF, 5 Khz-600 Ghz.

The system may also comprise an input unit 920 for receiving information or commands from the user of the system. The input unit 920 may comprise a microphone that can be used to receive voice commands from the user. The voice commands from the user may relate to the activation of the beam emitter. The voice commands may relate to interaction with the device or object the beam is pointing at. The input unit 920 may enable the user to control the number of beams generated by the device. The input unit 920 may enable the user to control the width of the beam, to reduce the effort required by the user to focus on the specific item to interact with. The input unit may enable the user to control the beam's width, for example by selecting to use “broad” beam, “medium” or “narrow” according to predefined rules or preferences. The input unit 920 may enable the user to set priorities and/or permissions to other possible users regarding the level of control, access, data, and identification of items within the system.

The system may also comprise a memory 930 for storing information. The memory 930 may store a set of instructions for performing the methods disclosed herein. The memory 930 may also store preferences inputted by the user, commands or information to be sent to other devices, and the like.

The wearable device comprises one or more sensors 940. The sensors comprise a main sensor directed towards the user's eye, for detecting the eye's direction. The main sensor may be an image sensor, such as a camera.

In some cases, the sensors 940 may comprise motion sensors for collecting information concerning motion of the wearable device. For example, the wearable device may comprise at least one tilt sensor or a combination of such sensors. The wearable device may comprise an accelerometer that may be used to measure proper acceleration—i.e., the acceleration experienced relative to freefall. The accelerometer may measure single and/or multi-axis models available to detect magnitude and direction of the acceleration as a vector quantity. The sensors 940 can be used to sense position, vibration and shock. The motion sensor may be a gyroscope for measuring or maintaining orientation, based on the principles of conservation of angular momentum. The motion sensor may be a tilt sensor defined as a device and/or component that can measure the tilting between two axes of a reference plane in two axes. The motion sensor may be used to assist the wearable device is determining the relative direction and/or relative distance of signals relative to the wearable device.

The wearable device may also comprise a compass. The compass may be used to determine the wearable device orientation, thus being used as part of the filtration process. For example, the processor may use data collected by the compass to determine which devices to filter and which devices to interact with.

The wearable device comprises a processor 950 that manages the operation of the electrical components of the wearable device. The processor 950 may include one or more processors, microprocessors, and any other processing device. The processor 950 is coupled to the sensors 940 for collecting the eye's direction. The processor 950 is coupled to the memory 930 for executing a set of instructions stored in the memory 930. The processor 950 may instruct the beam emitter 960 to generate a beam at the direction of the user's eye. The processor 950 may determine properties of the beam, such as amplitude, frequency, power, phase, width and the like. The processor 950 may add information to the beam. The processor 950 may send commands to the beam emitter 960 over wired communication or over a wireless technique such as Blue-Tooth, RF and the like.

The wearable device may also comprise a Direction Finding (DF) unit 980 for finding the relative direction and/or the relative distance of a device or a source of a signal relative to the sensors 940 of the wearable device. The DF unit 980 may be RF-Based (radio). The DF unit 980 may be audio/sound-based. The DF unit 980 may be light-based. The DF unit 980 may be used to determine the relative direction between the wearable device to other wearable devices or electronic devices, or devices that emit a signal, such as an audio signal, light signal, vibration signal and the like. The DF unit 980 may include at least one antenna used for the DF. The DF unit 980 may be located in different parts or sides of the wearable device. The DF unit 980 may include RF absorbing materials as part of the DF unit 980. The DF unit 980 may be UWB-based DF techniques and/or methods. The DF unit 980 may apply at least one DF mean or combination of DF means.

The wearable device may also comprise a beam emitter 960 for emitting a beam at a direction of the user's eye as detected by the sensor 940. The beam emitter 960 may be placed at the frame of the wearable device. The beam emitter 960 may comprise multiple emitters for emitting more than one beam concurrently. For example, a user may be in the living room and wish to interact a device in the kitchen. However, there are several devices in the kitchen, and by having the capability to send beams to several devices at the same time, the user may control these devices more easily without the need to shift his look.

The wearable device may also comprise a beam actuator 955 for moving the beam emitter 960. The beam actuator may receive commands from the processor 950 as to the direction of the user's look as detected by the sensors 940. The beam actuator 955 may direct the beam emitter 960 towards one or more commonly used items located in proximity to one another. For example, a user may look at his kitchen, if a direction that have a refrigerator, kettle, and oven right next to one another. If the kettle is the more commonly used item by the user, the beam emitter 960 may focus on the kettle first.

The wearable device may also comprise a user interface for providing information to the user. The user interface may comprise a display or a speaker. The user interface may be used by the device to display and/or provide information to the user or receive information from the user.

The wearable device may also comprise at least one camera 970 for capturing images. The camera 970 may be directed away from the user's face or body. The camera 970 may move in accordance with the direction of the beam emitter 960. The camera 970 may be constructed in an expendable mean, so an element of the wearable device may be protruded and/or extended in a given direction, to enable better LOS for the camera mean.

The wearable device may also comprise a location determination unit such as (but not limited to) GPS, Cellular, Wi-Fi, BT, UWB, and any other applicable technology and technique to enable location determination indoors and/or outdoors.

The subject matter may disclose at least 2 wearable devices, that may communicate wirelessly directly with one another. The multiple wearable devices may determine their relative position (relative direction, distance, orientation, altitude) relative to each other.

The wearable device and its circuitry may function as part of a smart home system. The wearable device and its circuitry may function using a smart home/hub and/or smart home speaker to relay data, commands and information to/from the electronic device to a tag/device. The wearable device and its circuitry may function using a smart phone and/or smart watch and/or smart cloth to relay data, commands and information to/from the electronic device to a tag/item. The wearable device and its circuitry may be coated in protective materials to protect the eyes of the user when a laser from a different similar electronic device is pointed to it. The wearable device and its circuitry may comprise two or more said electronic device, each can function as a detecting electronic device and/or as a detected device simultaneously.

While the disclosure has been described with reference to exemplary embodiments, it will be understood by those skilled in the art that various changes may be made, and equivalents may be substituted, for elements thereof without departing from the scope of the invention. In addition, many modifications may be made to adapt a particular situation or material to the teachings without departing from the essential scope thereof. Therefore, it is intended that the disclosed subject matter not limit the invention to any particular embodiment thereof

What is claimed is:

1. A system, comprising:
a wearable device, comprising:
a sensor directed towards the person's eyes, for detecting a direction at which the person looks;
a beam emitter for emitting a beam at the direction at which the person looks as detected by the sensor;
a processor for activating the beam emitter to emit the beam at the direction at which the person looks as detected by the sensor;
an electronic device, coupled to a tag, wherein the tag reacts when the beam hits the tag, wherein the reaction comprises performing an action at the electronic device.

2. The system according to claim 1, wherein the wearable device further comprising an input unit for receiving an input from a user of the wearable device concerning an action desired to be performed by the electronic device, and wherein performing the action in response to the beam hitting the tag.

3. The system according to claim 1, wherein the wearable device further comprising a direction finding unit for determining a relative direction of the tag relative to the wearable device.

4. The system of claim 1, wherein the beam comprises information collected at the electronic device.

5. The system of claim 1, further comprises an actuator for moving the beam emitter towards the direction at which the person looks.

6. The system of claim 1, further comprises multiple beam emitters, wherein the processor is coupled to the sensor and to the multiple beam emitters, wherein the processor selects a selected beam emitter from the multiple beam emitters.

7. The system of claim 6, wherein the processor selects at least two beam emitters from the multiple beam emitters, wherein the at least two beam emitters emit beams concurrently at multiple electronic devices.

8. The system of claim 1, further comprises an input unit for receiving an input from a user of the wearable device, said input comprising an interaction method with the electronic device.

9. The system of claim 1, further comprising a camera and a camera actuator, wherein the camera actuator moves the camera towards the direction at which the person looks.

10. A wearable device worn by a person, comprising:
a sensor directed towards the person's eyes, for detecting a direction at which the person looks;
a beam emitter for emitting a beam at the direction at which the person looks as detected by the sensor; and
a processor for activating the beam emitter to emit the beam at the direction at which the person looks as detected by the sensor.

11. The device of claim 10, wherein the beam emitter is a laser beam emitter.

12. The device of claim 10, wherein the beam emitter is a light beam emitter.

13. The device of claim 10, further comprises an actuator for moving the beam emitter towards the direction at which the person looks.

14. The device of claim 10, further comprises multiple beam emitters, wherein the processor is coupled to the sensor and to the multiple beam emitters, wherein the processor selects a selected beam emitter from the multiple beam emitters.

15. The device of claim 14, wherein the processor selects at least two beam emitters from the multiple beam emitters, wherein the at least two beam emitters emit beams concurrently at multiple electronic devices.

16. The device of claim 10, further comprises an input unit for receiving an input from a user of the wearable device, said input comprising an interaction method with the electronic device.

17. The device of claim 16, wherein the input unit comprises an interface in which the user of the wearable device determines a width of the beam.

18. The device of claim 10, wherein the processor identifies multiple electronic devices located in the direction at which the person looks and selects a selected electronic device of the multiple electronic devices based on predefined rules.

19. The device of claim 10, wherein the processor identifies the person based on predefined rules and operates the beam emitter based on the person's identity and preferences associated with the identified person as stored in a memory coupled to the processor.

20. The device of claim 10, wherein the beam comprises information collected at the electronic device.

21. The device of claim 10, further comprising a camera and a camera actuator, wherein the camera actuator moves the camera towards the direction at which the person looks.

22. The device of claim 10, further comprises a sensor, wherein information collected from the sensor is transferred to the processor, wherein the processor determines how to use the beam emitter based on the collected information.

23. The device of claim 10, wherein the wearable device is glasses, wherein the glasses comprise a lens coating for coating the glasses lens to reduce exposure to the beam.

24. The device of claim 10, further comprising a wireless communication unit for sending a wireless signal to an electronic device at which the beam is emitted.
